(19) United States
(12) Patent Application Publication
(10) Pub. No.: US 2011/0064197 A1
(43) Pub. Date: Mar. 17, 2011

(54) X-RAY DIFFRACTION DEVICES AND METHOD FOR ASSEMBLING AN OBJECT IMAGING SYSTEM

(76) Inventors: Geoffrey Harding, Humburg (DE); Stephan Olesinski, Hamburg (DE); Dirk Kosciesza, Pinneberg (DE); Helmut Rudolf Otto Strecker, Hamburg (DE)

(21) Appl. No.: 12/561,117

(22) Filed: Sep. 16, 2009

(51) Int. Cl. G01N 23/20

(52) U.S. Cl. 378/70

(57) ABSTRACT

A multiple-plane X-ray diffraction imaging (XDI) device for generating an X-ray diffraction (XRD) profile of an object is described. The XDI device includes an X-ray source configured to generate X-rays and a first primary collimator configured to generate a first primary X-ray fan-beam. The XDI device also includes a second primary collimator configured to generate a second primary X-ray fan-beam. The XDI device also includes a first scatter detector array configured to detect a first set of scattered radiation generated upon intersection of the first primary X-ray fan-beam with the object, and a second scatter detector array configured to detect a second set of scattered radiation generated upon intersection of the second primary X-ray fan-beam with the object.

### BACKGROUND OF THE INVENTION

1. Field of the Invention

The field of the disclosure relates to object imaging systems generally, and more specifically, to an X-ray diffraction device and a method for operating an object imaging system having such an X-ray diffraction device.

2. Description of Related Art

Security precautions, for example, screening of baggage and/or persons, may be desired to reduce the presence of restricted materials on one side of a security checkpoint. For example, a security checkpoint may be positioned at an entrance to an office building or government building to facilitate preventing weapons from being present within the building. In another example, a security checkpoint is positioned within a travel hub, for example, an airport. The security checkpoint is positioned to facilitate preventing weapons and/or hazardous materials from being present on a corresponding form of mass transit, for example, on an aircraft. There are many other situations in which determining whether a person is carrying restricted materials on their person or within baggage is an integral step in a security protocol.

In some examples, X-ray imaging is employed within a screening system. X-ray imaging may include X-ray diffraction imaging (XDI) for generating X-ray diffraction (XRD) profiles of a scanned object, for example, a piece of luggage. As a matter of background, it is customary to refer to each generation of XDI in terms of the number of dimensions of information that are acquired in parallel. For example, third generation XDI includes arrays of two-dimensional (2-D) pixellated detectors, in which each detector element pixel has energy resolving capability, allowing all momentum values of the XRD profile to be measured simultaneously. Third generation single-plane XDI can be realized with various fan-beam geometries, for example, divergent fan-beam (DFB), parallel fan-beam (PFB), and inverse fan-beam (IFB) geometries.

XDI accuracy depends on the ability to discriminate between harmless materials and the restricted materials of interest. Detection rate and false alarm rate are correlated in XDI to the photon statistics with which XRD profiles are acquired. Increased measurement times may produce higher detection rates and lower false alarm rates. However, increasing measurement times may increase an inconvenience felt by those passing through the security checkpoint or may not allow for scanning of large quantities of cargo within an acceptable length of time. These conflicting requirements may be resolved by “massively parallel” measurement schemes, in which many separate detector elements each measure one-on-one the small angle scatter from corresponding object voxels.

Accordingly, it would be desirable to reduce total XDI measurement time, increase an XDI detection rate, and maintain or reduce an XDI false alarm rate.

### BRIEF DESCRIPTION OF THE INVENTION

In one aspect, a multiple-plane X-ray diffraction imaging (XDI) device for generating an X-ray diffraction (XRD) profile of an object is provided. The XDI device includes an X-ray source configured to generate X-rays and a first primary collimator configured to generate a first primary X-ray fan-beam from the X-rays. The XDI device also includes a second primary collimator configured to generate a second primary X-ray fan-beam from the X-rays. The XDI device also includes a first scatter detector array configured to detect a first set of scattered radiation generated upon intersection of the first primary X-ray fan-beam with the object, and a second scatter detector array configured to detect a second set of scattered radiation generated upon intersection of the second primary X-ray fan-beam with the object.

In another aspect, an object imaging system is provided. The object imaging system includes an X-ray source configured to generate X-rays and a first primary collimator configured to generate a first primary X-ray fan-beam. The object imaging system also includes a second primary collimator configured to generate a second primary X-ray fan-beam. The object imaging system also includes a support for positioning an object downstream from the first primary collimator and the second primary collimator. The object imaging system also includes a first scatter detector array configured to detect a first set of scattered radiation generated upon intersection of the first primary X-ray fan-beam with the object, and a second scatter detector array configured to detect a second set of scattered radiation generated upon intersection of the second primary X-ray fan-beam with the object. The object imaging system also includes at least one processing device coupled to the first scatter detector and to the second scatter detector and configured to generate at least a portion of a diffraction profile from the first set of scattered radiation and the second set of scattered radiation.

In yet another aspect, a method for assembling an object imaging system is provided. The method includes configuring at least one X-ray source/primary collimator combination to generate a plurality of X-ray diffraction (XRD) fan-beams that include a first primary XRD fan-beam and a second primary XRD fan-beam. The first XRD fan-beam is directed toward a first X-ray detector with at least one object positioned between the X-ray source and the first X-ray detector. The second XRD fan-beam is directed toward a second X-ray detector with the at least one object positioned between the X-ray source and the second X-ray detector. At least a portion of the first X-ray fan-beam is scattered within a portion of the at least one object to form a first X-ray scatter beam, and at least a portion of the second X-ray fan-beam is scattered within a portion of the at least one object to form a second X-ray scatter beam. The first X-ray detector is configured to detect the first X-ray scatter beam and the second X-ray detector is configured to detect the second X-ray scatter beam. A processing system is coupled to the first X-ray detector and the second X-ray detector and is configured to generate at least a portion of an XRD profile from the first X-ray scatter beam and the second X-ray scatter beam.

### BRIEF DESCRIPTION OF THE DRAWINGS

FIGS. 1-7 show exemplary embodiments of the methods and systems described herein.

FIG. 1 is a schematic perspective view of an exemplary object imaging system that includes a multiple-plane fan-beam XDI device.

FIG. 2 is a schematic perspective view of an exemplary divergent multiple-plane fan-beam XDI device that may be used with the object imaging system shown in FIG. 1.

FIG. 3 is a perspective view of an alternative exemplary parallel multiple-plane fan-beam XDI device that may be used with the object imaging system shown in FIG. 1.

FIG. 4 is a perspective view of an alternative exemplary divergent multiple-plane fan-beam XDI device that may be used with the object imaging system shown in FIG. 1.

FIG. 5 is a perspective view of another exemplary multiple-plane fan-beam XDI device that may be used with the object imaging system shown in FIG. 1.

FIG. 6 is a flow diagram illustrating an exemplary method for operating an object imaging system.

FIG. 7 is a flow diagram illustrating an exemplary method for assembling an object imaging system.

### DETAILED DESCRIPTION OF THE INVENTION

Embodiments of the method, devices, and systems described herein facilitate effective and efficient operation of an object imaging system by decreasing scan times compared to scan times of object imaging systems that use single-plane X-ray diffraction fan-beams, through the use of multiple-plane X-ray diffraction fan-beams. Moreover, the multiple-plane X-ray diffraction fan-beams described herein may be generated without increasing the number of X-ray sources when compared to a system using single-plane X-ray diffraction fan-beams. The multiple-plane X-ray diffraction fan-beams facilitate substantial parallel imaging and analysis of objects under scrutiny. Therefore, the methods, devices, and systems described herein provide the user with a visual three-dimensional (3-D) image of the objects under scrutiny in a reduced measurement time when compared to a system using a single-plane X-ray diffraction fan-beam. Furthermore, a detection rate may be increased and/or a false alarm rate may be decreased through use of an object imaging system that uses the multiple-plane X-ray diffraction fan-beams described herein.

The object imaging systems described herein include a multiple-plane XDI device that facilitates substantial parallel imaging and analysis of objects under scrutiny, in some embodiments, without increasing a number of X-ray sources compared to known single-plane XDI devices. In some embodiments, such multiple-plane XDI devices generate multiple X-ray fan-beams in which all object volume elements (voxels) in a three-dimensional (3-D) object section are analyzed in parallel to generate a 3-D image of the object and contents residing therein. Therefore, the method and multiple-plane XDI devices disclosed herein facilitate providing the user with a visual 3-D image of the objects under scrutiny at a lower cost and with faster results, substantially regardless of the physical attributes of the scrutinized objects, when compared to single-plane XDI devices.

A source geometry relationship is described herein whereby a multiple-plane XDI device may include an X-ray source having the same source geometry as an X-ray source used in a single-plane XDI device. The dimensionality of the X-ray source of the multiple-plane XDI device is either identical or incremented by one relative to the X-ray source of the single-plane XDI device. Examples of single-plane XDI devices include a divergent fan-beam (DFB) XDI device, an inverse fan-beam (IFB) XDI device, and a parallel fan-beam (PFB) XDI device. In contrast to single-plane XDI devices, the methods, systems, and devices described herein relate to generating multiple fan-beams. The multiple-plane XDI devices described herein generate multiple fan-beams, wherein each fan-beam occupies a separate plane. In exemplary embodiments, each fan-beam plane is parallel to the other fan-beam planes. For example, the multiple-plane XDI devices described herein may generate multiple parallel DFBs, multiple parallel IFBs, and/or multiple parallel PFBs. In alternative embodiments, each fan-beam plane diverges from the other fan-beam planes. For example, the multiple-plane XDI devices described herein may generate multiple divergent DFBs, multiple divergent IFBs, and/or multiple divergent PFBs. Each multiple-plane XDI device described herein is configured to prevent interference between the multiple fan-beams. For example, each fan-beam plane is positioned such that a distance between scatter collimator/detector combinations is not less than a minimum distance that prevents coherent scatter of one fan-beam from interfering with another fan-beam. Alternatively, to prevent the multiple fan-beams from interfering with one another, scatter collimators may be configured to only allow fan-beams having an angle of incidence below a maximum angle to reach the detector.

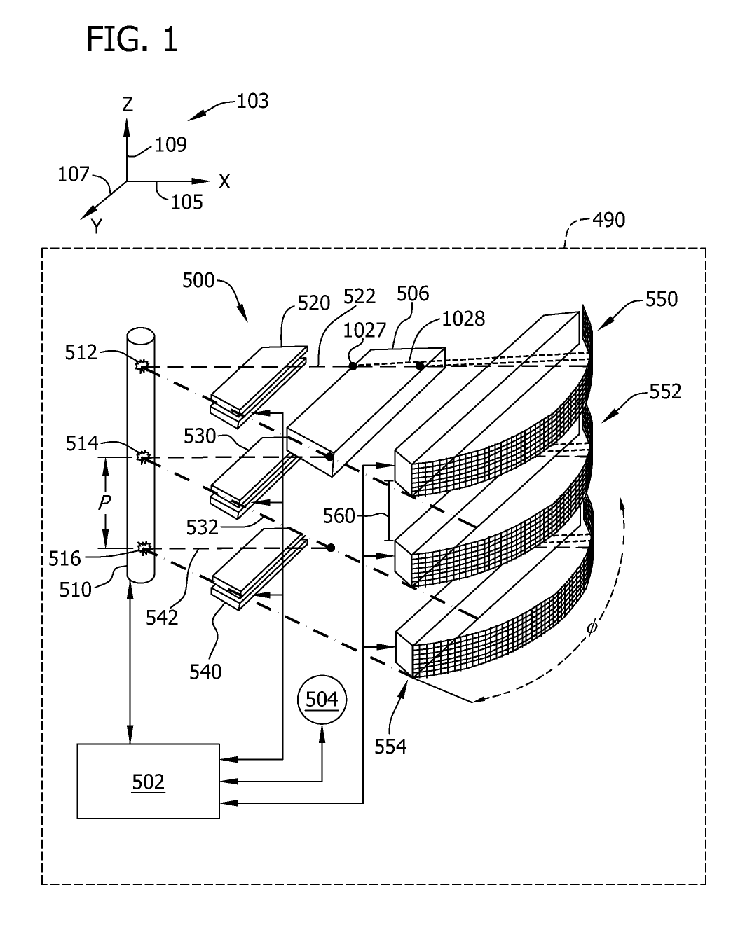

FIG. 1 is a schematic perspective view of an exemplary object imaging system 490. In the exemplary embodiment, object imaging system 490 includes a parallel multiple-plane fan-beam XDI device 500. Object imaging system 490 also includes a computer processing system 502, and a belt and belt drive apparatus 504. Object imaging system 490 may be integrated within a larger, more comprehensive security system (not shown in FIG. 1). The security system may be configured to operate both for checked luggage and carry-on luggage in airport security as well as at security checkpoints where the security system is configured to scan larger-profile items, such as suitcases and shipping crates. Computer processing system 502 includes sufficient information technology resources to record, analyze, synthesize, and correct data collected. Data processing techniques facilitate forming a three-dimensional (3-D) image representative of an object 506 and contents therein. Computer processing system 502 may be dedicated to object imaging system 490 or integrated within a larger processing system associated with a remainder of the security system. In the exemplary embodiment, computer processing system 502 may include equipment (not shown) such as, but not limited to, printers, desktop computers, laptop computers, servers, and hand-held devices, such as personal data assistants (PDAs), that perform system and network functions that include, but are not limited to, diagnostics, reporting, technical support, configuration, system and network security, and communications.

In the exemplary embodiment, multiple-plane fan-beam XDI device 500 includes a linear multi-focus X-ray source 510 (hereinafter referred to as X-ray source 510). Alternatively, X-ray source 510 may be any source emitting any suitable form of radiation that allows XDI device 500 to function as described herein. Linear multi-focus X-ray source 510 includes multiple X-ray sources, for example, X-ray sources 512, 514, and 516, each lying at finite points on a line. X-ray source 510 is described herein as having a dimensionality of one, also referred to herein as unity. For illustration and perspective, FIG. 1 shows a coordinate system 103 that includes an x-axis 105 (substantially representing a vertical dimension), a y-axis 107 (substantially representing a horizontal, longitudinal, or lengthwise dimension), and a z-axis 109 (substantially representing a depth, traverse, or widthwise dimension). Each axis is orthogonal to each other axis. Defining orientation of object imaging system 490 and XDI device 500 with coordinate system 103 as described herein facilitates consistent perspective within this disclosure. Alternatively, any orientation of object imaging system 490 and XDI device 500 may be used, without limitation, that enables object imaging system 490 to function as described herein.

In the exemplary embodiment, a first primary collimator 520 generates a first divergent fan-beam 522 from X-rays emitted by X-ray source 510. A second primary collimator 530 generates a second divergent fan-beam 532 from X-rays emitted by X-ray source 510. Also, in the exemplary embodiment, a third primary collimator 540 generates a third divergent fan-beam 542 from X-rays emitted by X-ray source 510. Although illustrated as including three primary collimators 520, 530, and 540, XDI device 500 may include any suitable number of primary collimators that allow XDI device 500 to function as described herein. During operation, object 506 is moved in the z direction of magnitude, P, the source pitch, until the complete object 506 is analyzed. Computer processing system 502 substantially controls and coordinates operation of X-ray source 510, first primary collimator 520, second primary collimator 530, third primary collimator 540, and belt drive apparatus 504 to illuminate object 506 with X-ray fan-beams 522, 532, and 542 as described herein. One technical effect of multiple-plane fan-beam XDI device 500 as described herein is to facilitate collection and analysis of diffraction profiles for multiple 2-D planes of object 506 at substantially the same time, rather than collection and analysis of a diffraction profile for a single 2-D plane of object 506.

In the exemplary embodiment, first divergent fan-beam 522 is parallel to second divergent fan-beam 532. More specifically, both first divergent fan-beam 522 and second divergent fan-beam 532 are parallel to the x-y plane. Additionally, third divergent fan-beam 542 is also parallel to the x-y plane. Because of the parallel alignment of the multiple divergent fan-beams, multiple-plane fan-beam XDI device 500 may be referred to as a parallel multiple divergent fan-beam XDI device. XDI device 500 may also be referred to as a parallel multiple-plane DFB XDI device.

In the exemplary embodiment, XDI device 500 includes a first scatter collimator/detector combination 550, a second scatter collimator/detector combination 552, and a third scatter collimator/detector combination 554. Combinations 550, 552, and 554 are configured to receive at least a portion of X-ray scatter beams and primary X-ray beams and to output an energy spectrum that is processed to yield an XRD profile. Although illustrated as including three scatter collimator/detector combinations 550, 552, and 554, XDI device 500 may include any suitable number of scatter collimator/detector combinations that allow XDI device 500 to function as described herein. In the exemplary embodiment, first scatter collimator/detector combination 550 is positioned a distance 560 from second scatter collimator/detector combination 552. Distance 560 is determined such that distance 560 between scatter collimator/detector combinations 550 and 552 is not less than a minimum distance that prevents coherent scatter of fan-beam 532 from reaching scatter collimator/detector combination 550 and coherent scatter of fan-beam 522 from reaching scatter collimator/detector combination 552. In some exemplary embodiments, distance 560 is not less than one hundred millimeters. In an alternative embodiment, first scatter collimator of first scatter collimator/detector combination 550 is configured to only allow fan-beams having an angle of incidence below a maximum angle to reach the detector. For example, by blocking fan-beams having an angle of incidence of greater than ten degrees relative to first scatter collimator/detector combination 550, fan-beam 522 will reach the detector of scatter collimator/detector combination 550, however, coherent scatter of fan-beam 532 will be blocked by the first scatter collimator of first scatter collimator/detector combination 550.

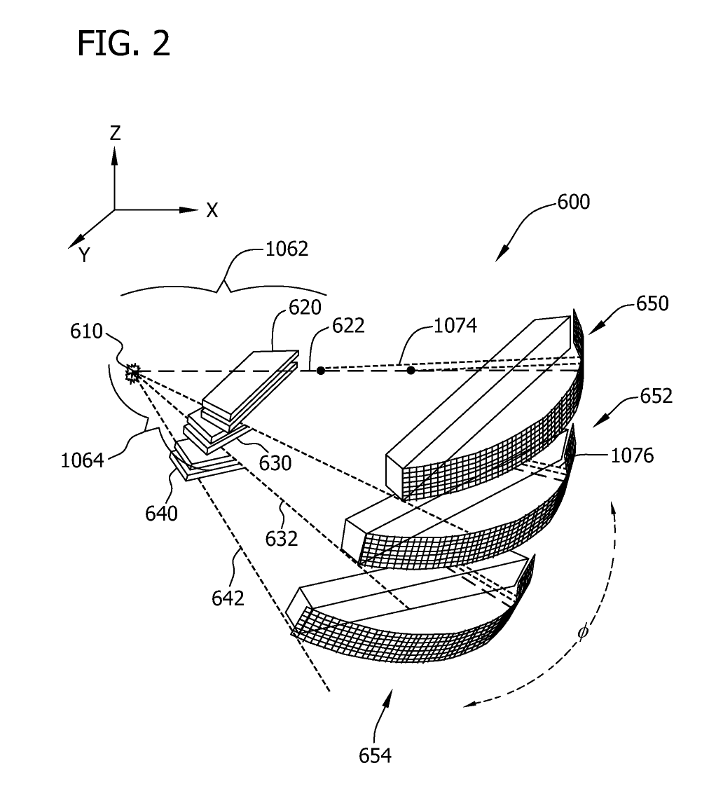

FIG. 2 is a schematic perspective view of an alternative embodiment of a multiple-plane fan-beam XDI device 600 that may be used with object imaging system 490 (shown in FIG. 1). Multiple-plane fan-beam XDI device 500 (shown in FIG. 1) and multiple-plane fan-beam XDI device 600 both generate multiple DFBs. XDI device 500 generates multiple parallel DFBs. In the alternative embodiment, XDI device 600 generates multiple divergent DFBs.

Multiple-plane fan-beam XDI device 600 includes a single point X-ray source 610 (i.e., a source dimensionality of zero). As described above, the dimensionality of the source refers to its geometric form. A small X-ray focus is regarded as an approximation to a geometric point having dimensionality zero. Multiple-plane fan-beam XDI device 600 simultaneously irradiates all object planes with a divergent cone of radiation emitted by single point X-ray source 610. A first primary collimator 620 generates a first divergent fan-beam 622 from X-rays emitted by X-ray source 610. A second primary collimator 630 generates a second divergent fan-beam 632 from X-rays emitted by X-ray source 610. Also, in the exemplary embodiment, a third primary collimator 640 generates a third divergent fan-beam 642 from X-rays emitted by X-ray source 610. Although illustrated as including three primary collimators 620, 630, and 640, XDI device 600 may include any suitable number of primary collimators that allow XDI device 600 to function as described herein. For example, XDI device 600 may include a single primary collimator that generates multiple divergent fan-beams from the X-rays generated by X-ray source 610. As described above with respect to FIG. 1, an object (not shown in FIG. 2) is moved past first, second, and third divergent fan-beams 622, 632, and 642 until the complete object is analyzed.

In the alternative embodiment, first, second, and third divergent fan-beams 622, 632, and 642 originate at point source 610, and are divergent with respect to each of the other fan-beams. More specifically, first, second, and third divergent fan-beams 622, 632, and 642 extend radially outward from point source 610. Because of the diverging alignment of the multiple divergent fan-beams 622, 632, and 642, multiple-plane fan-beam XDI device 600 may be referred to as a divergent multiple divergent fan-beam XDI device. XDI device 600 may also be referred to as a divergent multiple-plane DFB XDI device.

In the alternative embodiment, XDI device 600 includes a first scatter collimator/detector combination 650, a second scatter collimator/detector combination 652, and a third scatter collimator/detector combination 654. Combinations 650, 652, and 654 are configured to receive at least a portion of X-ray scatter beams and primary X-ray beams and to output an energy spectrum that is processed to yield an XRD profile. Although illustrated as including three scatter collimator/detector combinations 650, 652, and 654, XDI device 600 may include any suitable number of scatter collimator/detector combinations that allow XDI device 600 to function as described herein.

At least some examples of single-plane DFB XDI devices include a point X-ray source which has a dimensionality of zero. As described herein, a multiple-plane DFB XDI device may include an X-ray source having a dimensionality of one (e.g., parallel multiple-plane XDI device 500, shown in FIG. 1) or an X-ray source having a dimensionality of zero (e.g., divergent multiple-plane XDI device 600, shown in FIG. 2). In other words, the source dimensionality for multiple-plane DFB XDI may either be zero, the same as at least some known single-plane DFB XDI devices, or incremented by one to unity.

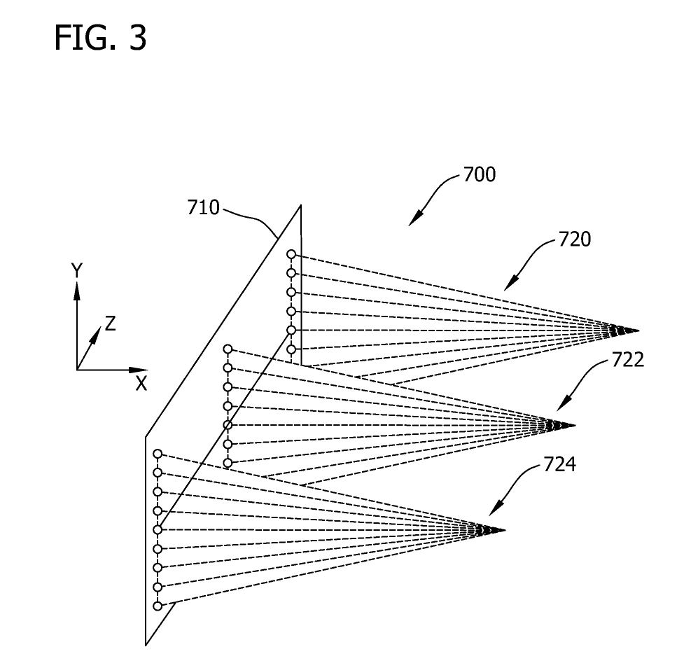

FIG. 3 is a perspective view of an exemplary multiple-plane fan-beam XDI device 700 that may be used with object imaging system 490 (shown in FIG. 1). Again, for simplicity, only the primary X-ray beams are shown and other components, such as secondary collimators and detector arrays are not shown. More specifically, multiple-plane fan-beam XDI device 700 generates a parallel multiple-plane IFB XDI geometry. In the exemplary embodiment, an X-ray source/primary collimator combination 710 generates multiple parallel IFBs, for example, a first fan-beam 720, a second fan-beam 722, and a third fan-beam 724. Although illustrated as including three fan-beams 720, 722, and 724, any number of parallel fan-beams that allow XDI device 700 to function as described herein may be included. X-ray source/primary collimator combination 710 includes an X-ray source having a dimensionality of two, or in other words, a 2-D distributed pixellated source. As described above with respect to FIG. 1, an object (not shown in FIG. 3) is moved past first, second, and third inverse fan-beams 720, 722, and 724 until the complete object is analyzed. Because of the parallel alignment of the multiple inverse fan-beams 720, 722, and 724, XDI device 700 may be referred to as a parallel multiple inverse fan-beam XDI device. XDI device 700 may also be referred to as a parallel multiple-plane IFB XDI device.

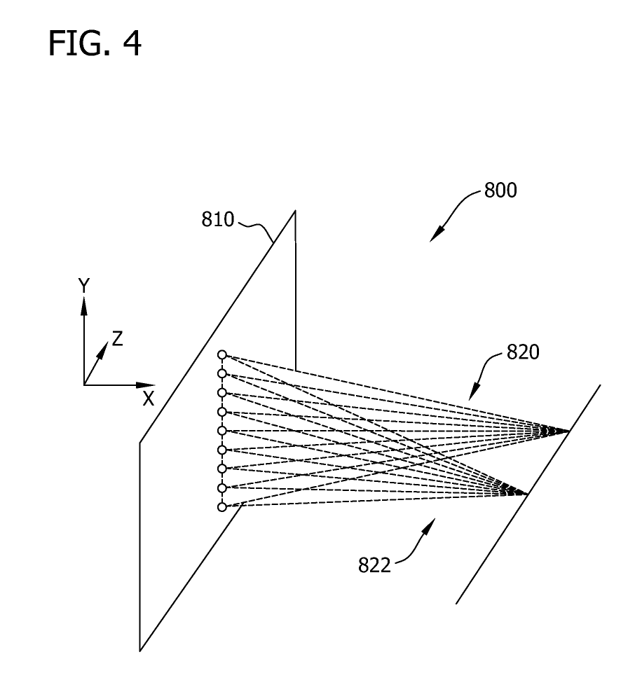

FIG. 4 is a perspective view of another alternative embodiment of a multiple-plane fan-beam XDI device 800 that may be used with object imaging system 490 (shown in FIG. 1). XDI device 700 (shown in FIG. 3) and XDI device 800 both generate multiple IFBs. XDI device 700 generates multiple parallel IFBs. In the alternative embodiment, XDI device 800 generates multiple diverging IFBs.

Once again, for simplicity, only the primary X-ray beams are shown and other components, such as secondary collimators and detector arrays are not shown. In the exemplary embodiment, an X-ray source/primary collimator combination 810 generates multiple diverging IFBs, for example, a first fan-beam 820 and a second fan-beam 822. Although illustrated as including two fan-beams 820 and 822, any number of diverging fan-beams that allow XDI device 800 to function as described herein may be included. X-ray source/primary collimator combination 810 includes a linear segmented multi-focus X-ray source having a dimensionality of one. Because of the diverging alignment of the multiple inverse fan-beams 820 and 822, multiple-plane fan-beam XDI device 800 may be referred to as a divergent multiple inverse fan-beam XDI device. Multiple-plane fan-beam device 800 may also be referred to as a divergent multiple-plane IFB XDI device.

At least some known single-plane IFB XDI devices include a linear multi-focus X-ray source that has a dimensionality of one. As described herein, a multiple-plane IFB XDI device may include an X-ray source having a dimensionality of two (e.g., parallel multiple-plane IFB XDI device 700, see FIG. 3) or an X-ray source having a dimensionality of one (e.g., divergent multiple-plane IFB XDI device 800, see FIG. 4). In other words, the source dimensionality for multiple-plane IFB XDI may either be one, the same as at least some known single-plane IFB XDI devices, or incremented by one to two.

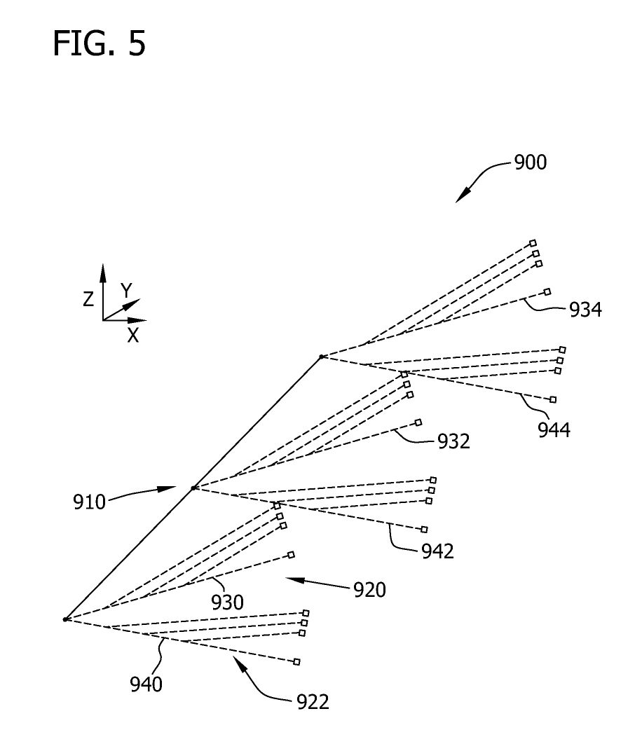

FIG. 5 is a perspective view of another exemplary multiple-plane fan-beam XDI device 900 that may be used with object imaging system 490 (shown in FIG. 1). Once again, for simplicity, only the primary X-ray beams are shown and other components, such as primary collimators, secondary collimators and detector arrays are not shown. In the exemplary embodiment, an X-ray source/primary collimator combination 910 generates two diverging planes of PFBs, for example a first plane 920 and a second plane 922. In the exemplary embodiment, first plane 920 includes three primary beams 930, 932, and 934. Similarly, second plane 922 includes three primary beams 940, 942, and 944. Although illustrated as including two planes 920 and 922, any number of diverging planes that allow XDI device 900 to function as described herein may be included. X-ray source/primary collimator combination 910 includes a multi-focus X-ray source having a dimensionality of two. Because of the diverging alignment of the primary beams 930, 932, 934, 940, 942, and 944, multiple-plane fan-beam XDI device 900 may be referred to as a divergent multiple parallel fan-beam XDI device. Multiple-plane fan-beam device 900 may also be referred to as a divergent multiple-plane PFB XDI device. In an alternative embodiment, multiple-plane fan-beam XDI device 900 may be configured to generate multiple parallel PFBs. In the alternative embodiment, XDI device 900 may be referred to as a parallel multiple-plane PFB XDI device.

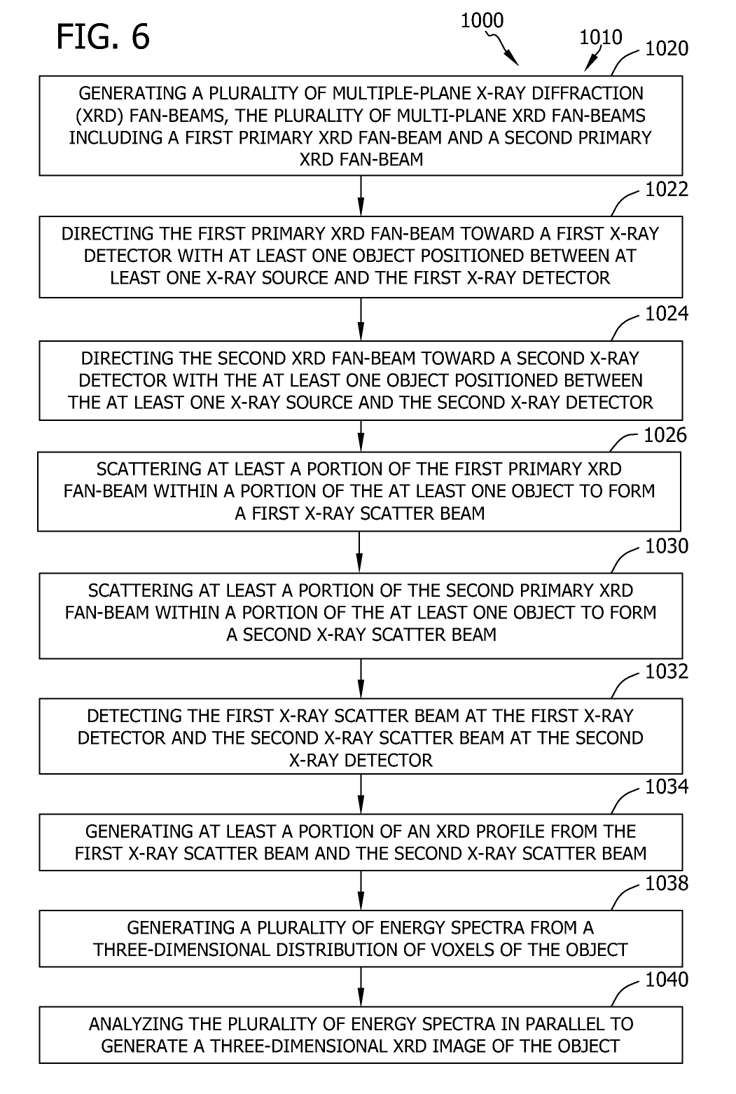

FIG. 6 is a flow diagram 1000 illustrating an exemplary method 1010 for operating an object imaging system, for example, object imaging system 490 (shown in FIG. 1). In the exemplary embodiment, method 1010 includes generating 1020 multiple-plane X-ray diffraction (XRD) fan-beams. In an exemplary embodiment, generating 1020 includes generating a multiple-plane divergent fan-beam (DFB). Generating 1020 multiple-plane XRD fan-beams may include generating 1020 a first primary XRD fan-beam and a second primary XRD fan-beam, for example, first primary fan-beam 522 (shown in FIG. 1) and second primary fan-beam 532 (shown in FIG. 1). Method 1010 also includes directing 1022 first primary fan-beam 522 toward at least a first X-ray detector, for example, scatter collimator/X-ray detector combination 550 (shown in FIG. 1). Method 1010 also includes directing 1024 second primary fan-beam 532 toward at least a second X-ray detector, for example, scatter collimator/X-ray detector combination 552 (shown in FIG. 1).

In the exemplary embodiment, method 1010 also includes scattering 1026 at least a portion of first primary XRD fan-beam 522 within a portion of an object, for example, object 506 (shown in FIG. 1) to form a first X-ray scatter beam. For example, as primary XRD fan-beam 522 encounters object 506 at point 1027 (shown in FIG. 1), a first X-ray scatter beam 1028 (shown in FIG. 1) is formed. Similarly, method 1010 also includes scattering 1030 at least a portion of second primary XRD fan-beam 532 within a portion of the object to form a second X-ray scatter beam.

In the exemplary embodiment, method 1010 also includes detecting 1032 the first X-ray scatter beam at the first X-ray detector, for example, first X-ray scatter beam 1028 at scatter collimator X-ray detector combination 550, and the second X-ray scatter beam at the second X-ray detector. Method 1010 still further includes generating 1034 at least a portion of an XRD profile from the first X-ray scatter beam and the second X-ray scatter beam.

Although described above with respect to multiple-plane DFB XDI, method 1010 is also applicable to multiple-plane IFB XDI and multiple-plane PFB XDI. For example, generating 1020 multiple-plane XRD fan-beams may include generating parallel multiple-plane DFBs (shown in FIG. 1), generating divergent multiple-plane DFBs (shown in FIG. 2), generating parallel multiple-plane IFBs (shown in FIG. 3), generating divergent multiple-plane IFBs (shown in FIG. 4), or generating divergent multiple-plane PFBs (shown in FIG. 5).

Furthermore, generating 1020 multiple-plane XRD fan-beams may include configuring a primary collimator, or multiple primary collimators, to generate divergent multiple-plane DFBs generated from X-rays provided by an X-ray source having a dimensionality of zero, for example, as is described above with respect to divergent multiple-plane DFB XDI device 600 (shown in FIG. 2). Generating 1020 multiple-plane XRD fan-beams may also include configuring multiple primary collimators to generate parallel multiple-plane DFBs generated from X-rays provided by an X-ray source having a dimensionality of one, for example, as is described above with respect to parallel multiple-plane DFB XDI device 500 (shown in FIG. 1).

Generating 1020 multiple-plane XRD fan-beams may also include configuring a primary collimator, or multiple primary collimators, to generate divergent multiple-plane IFBs generated from X-rays provided by an X-ray source having a dimensionality of one, for example, as is described above with respect to divergent multiple-plane IFB XDI device 800 (shown in FIG. 4). Generating 1020 multiple-plane XRD fan-beams may also include configuring multiple primary collimators to generate parallel multiple-plane IFBs generated from X-rays provided by an X-ray source having a dimensionality of two, for example, as is described above with respect to parallel multiple-plane IFB XDI device 700 (shown in FIG. 3).

In the exemplary embodiment, method 1010 also includes generating 1038 a plurality of energy spectra from a three-dimensional distribution of voxels of the object, and analyzing 1040 the plurality of energy spectra from the three-dimensional distribution of voxels in parallel to generate a three-dimensional XRD image of the object.

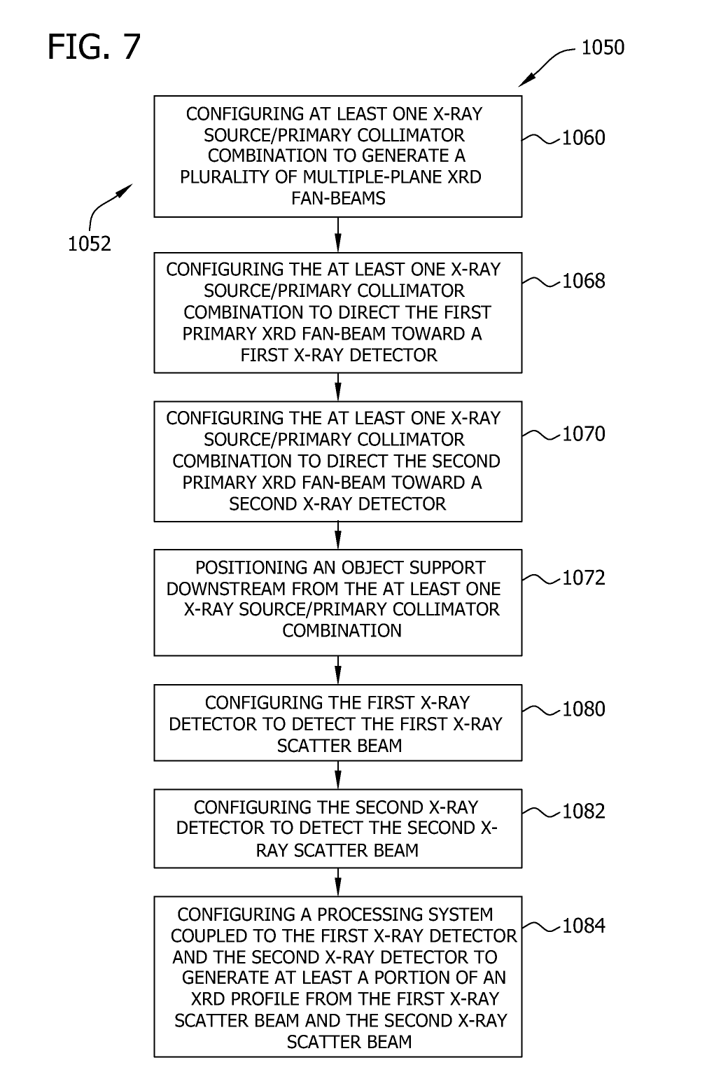

FIG. 7 is a flow diagram 1050 illustrating an exemplary method 1052 for assembling an object imaging system, for example, object imaging system 490 (shown in FIG. 1). In the exemplary embodiment, method 1052 includes configuring 1060 at least one X-ray source/primary collimator combination to generate a plurality of X-ray diffraction (XRD) fan-beams. For example, an X-ray source/primary collimator combination 1062 (shown in FIG. 2), which includes X-ray source 610 and primary collimator 620, and an X-ray source/primary collimator combination 1064 (shown in FIG. 2), which includes X-ray source 610 and primary collimator 630, are configured 1060 to generate a plurality of XRD fan-beams, for example, first primary fan-beam 622 and second primary fan-beam 632. Method 1052 also includes configuring 1068 the at least one X-ray source/primary collimator combination to direct first primary fan-beam 622 toward at least a first X-ray detector, for example, scatter collimator/X-ray detector combination 650 (shown in FIG. 2). Method 1052 also includes configuring 1070 the at least one X-ray source/primary collimator combination to direct second primary fan-beam 632 toward at least a second X-ray detector, for example, scatter collimator/X-ray detector combination 652 (shown in FIG. 2). Configuring 1070 the at least one X-ray source/primary collimator combination to direct second primary fan-beam 632 toward scatter collimator/X-ray detector combination 652 may include determining a distance between scatter collimator/X-ray detector combination 650 and scatter collimator/X-ray detector combination 652. The distance is determined to be greater than a minimum distance that prevents coherent scatter of fan-beam 622 from reaching scatter collimator/X-ray detector combination 652 and coherent scatter of fan-beam 632 from reaching scatter collimator/X-ray detector combination 650. Alternatively, a maximum scatter angle may be determined, and scatter collimator/X-ray detector combinations 650 and 652 may be configured to block fan-beams having an angle of incidence of greater than the maximum scatter angle.

In the exemplary embodiment, method 1052 also includes positioning 1072 an object support, for example, belt and belt drive apparatus 504 (shown in FIG. 1), downstream from the at least one X-ray source/primary collimator combination, wherein the object support is configured to position at least one object, for example, object 506 (shown in FIG. 1), such that at least a portion of first primary fan-beam 622 is scattered within object 506 to form a first X-ray scatter beam, for example, first X-ray scatter beam 1074 (shown in FIG. 2). The object support is also configured to position object 506 such that at least a portion of second primary fan-beam 632 is scattered within object 506 to form a second X-ray scatter beam, for example, second X-ray scatter beam 1076 (shown in FIG. 2). Method 1052 also includes configuring 1080 scatter collimator/X-ray detector combination 650 to detect first X-ray scatter beam 1074. Method 1052 further includes configuring 1082 scatter collimator/X-ray detector combination 652 to detect second X-ray scatter beam 1076. A processing system, for example, processing system 502 (shown in FIG. 1), is coupled to first scatter collimator/X-ray detector combination 650 and to second scatter collimator/X-ray detector combination 652. Processing system 502 is configured 1084 to generate at least a portion of an XRD profile from first X-ray scatter beam 1074 and second X-ray scatter beam 1076.

Although described above with respect to multiple-plane DFB XDI, method 1052 is also applicable to multiple-plane IFB XDI and multiple-plane PFB XDI. For example, configuring 1060 at least one X-ray source/primary collimator combination to generate a plurality of XRD fan-beams may include configuring at least one X-ray source/primary collimator combination to generate a plurality of parallel multiple-plane DFBs (shown in FIG. 1), configuring at least one X-ray source/primary collimator combination to generate a plurality of divergent multiple-plane DFBs (shown in FIG. 2), configuring at least one X-ray source/primary collimator combination to generate a plurality of parallel multiple-plane IFBs (shown in FIG. 3), configuring at least one X-ray source/primary collimator combination to generate a plurality of divergent multiple-plane IFBs (shown in FIG. 4), or configuring at least one X-ray source/primary collimator combination to generate a plurality of divergent multiple-plane PFBs (shown in FIG. 5).

Described herein are exemplary methods and systems for assembling and operating a security system. More specifically, the methods and systems described herein enable multiple-plane XDI. The methods and systems described herein facilitate effective and efficient operation of a security system by decreasing scan times through the use of multiple-plane X-ray diffraction fan-beams. In other words, a total length of time required to inspect an object may be reduced by collecting and analyzing multiple planes in parallel using the multiple-plane XDI systems described herein. Alternatively, measurement time for each plane may be increased without increasing a total length of time required to inspect the object relative to a single-plane XDI system. Moreover, the multiple-plane X-ray diffraction fan-beams may be generated without increasing the number of X-ray sources when compared to a system using a single-plane X-ray diffraction fan-beam. The multiple-plane X-ray diffraction fan-beams facilitate substantial parallel imaging and analysis of objects under scrutiny. Therefore, the methods and systems described herein provide the user with a visual three-dimensional (3-D) image of the object under scrutiny in a reduced measurement time when compared to a system using a single-plane X-ray diffraction fan-beam. Furthermore, a detection rate may be increased and a false alarm rate may be decreased through use of a security system that uses the multiple-plane XDI systems described herein.

The methods and systems described herein facilitate efficient and economical operation of a security system. Exemplary embodiments of methods and systems are described and/or illustrated herein in detail. The methods and systems are not limited to the specific embodiments described herein, but rather, components of each system, as well as steps of the method, may be utilized independently and separately from other components and steps described herein. Each component, and each method step, can also be used in combination with other components and/or method steps.

A first technical effect of the methods and multiple-plane XDI systems described herein is to provide a user of the security system with a reduction in the scanning time of each item being scrutinized. This first technical effect is at least partially achieved by substantially parallel imaging and analysis of objects under scrutiny. A second technical effect of the methods and systems described herein is to increase a detection rate associated with restricted substances and materials. A third technical effect of the methods and systems described herein is to decrease a false alarm rate associated with restricted substances and materials. The second and third technical effects are also at least partially achieved by substantially parallel imaging and analysis of objects under scrutiny. A fourth technical effect of the methods and systems described herein is to minimize a number of X-ray sources required to produce the multiple-plane XDI fan-beams. Minimizing the number of X-ray sources facilitates reducing capital, maintenance, and operational costs associated with ownership of such a security system.

At least one embodiment is described above in reference to its application in connection with, and operation of, a security system for screening people and/or baggage for restricted materials and alarming and/or notifying an operator when such a material is detected. However, it should be apparent to those skilled in the art that one or more embodiments described herein are likewise applicable to any suitable system requiring security screening of a large number of objects of varying shapes in a short time frame with little to no false alarms.

At least some of the components of the object imaging systems and security systems described herein include at least one processor and a memory, at least one processor input channel, and at least one processor output channel. As used herein, the term “processor” is not limited to those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may include, without limitation, computer peripherals associated with an operator interface such as a mouse and a keyboard. Alternatively, other computer peripherals may also be used that may include, for example, without limitation, a scanner. Furthermore, in the exemplary embodiment, additional output channels may include, without limitation, an operator interface monitor.

The processors as described herein process information transmitted from a plurality of electrical and electronic components that may include, but are not limited to, security system inspection equipment such as fan-beam X-ray diffraction imaging systems. Such processors may be physically located in, for example, the fan-beam X-ray diffraction imaging systems, desktop computers, laptop computers, PLC cabinets, and distributed control system (DCS) cabinets. RAM and storage devices store and transfer information and instructions to be executed by the processor. RAM and storage devices can also be used to store and provide temporary variables, static (i.e., non-changing) information and instructions, or other intermediate information to the processors during execution of instructions by the processors. Instructions that are executed include, but are not limited to, resident security system control commands. The execution of sequences of instructions is not limited to any specific combination of hardware circuitry and software instructions.

When introducing elements/components/etc. of the methods and apparatus described and/or illustrated herein, the articles “a,” “an,” “the,” and “said” are intended to mean that there are one or more of the element(s)/component(s)/etc. The terms “comprising,” “including,” and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A multiple-plane X-ray diffraction imaging (XDI) device for generating an X-ray diffraction (XRD) profile of an object, said XDI device comprising:
an X-ray source configured to generate X-rays;
a first primary collimator configured to generate a first primary X-ray fan-beam from the X-rays;
a second primary collimator configured to generate a second primary X-ray fan-beam from the X-rays;
a first scatter detector array configured to detect a first set of scattered radiation generated upon intersection of the first primary X-ray fan-beam with the object; and
a second scatter detector array configured to detect a second set of scattered radiation generated upon intersection of the second primary X-ray fan-beam with the object.

2. A multiple-plane XDI device in accordance with claim 1, wherein said X-ray source has a dimensionality of zero.

3. A multiple-plane XDI device in accordance with claim 2, wherein said first primary collimator is further configured to generate a first divergent X-ray fan-beam and said second primary collimator is configured to generate a second divergent X-ray fan-beam, wherein the first divergent X-ray fan-beam diverges from the second divergent X-ray fan-beam.

4. A multiple-plane XDI device in accordance with claim 1, wherein the X-ray source has a dimensionality of one.

5. A multiple-plane XDI device in accordance with claim 4, wherein said first primary collimator is configured to generate a first divergent X-ray fan-beam and said second primary collimator is configured to generate a second divergent X-ray fan-beam, wherein the first divergent X-ray fan-beam is substantially parallel to the second divergent X-ray fan-beam.

6. A multiple-plane XDI device in accordance with claim 4, wherein said first primary collimator is configured to generate a first inverse X-ray fan-beam and said second primary collimator is configured to generate a second inverse X-ray fan-beam, wherein the first inverse X-ray fan-beam diverges from the second inverse X-ray fan-beam.

7. A multiple-plane XDI device in accordance with claim 1, wherein the X-ray source has a dimensionality of two.

8. A multiple-plane XDI device in accordance with claim 7, wherein said first primary collimator is configured to generate a first inverse X-ray fan-beam and said second primary collimator is configured to generate a second inverse X-ray fan-beam, wherein the first inverse X-ray fan-beam is substantially parallel to the second inverse X-ray fan-beam.

9. A multiple-plane XDI device in accordance with claim 1, wherein said first scatter detector array and said second scatter detector array are configured to generate, in parallel, a plurality of electrical output signals based on the detected scattered radiation.

10. A multiple-plane XDI device in accordance with claim 9, wherein said first scatter detector array and said second scatter detector array are configured to output the plurality of electrical output signals to at least one processing device, wherein said at least one processing device is configured to generate an XRD profile from the electrical output signals.

11. An object imaging system, comprising:
an X-ray source configured to generate X-rays;
a first primary collimator configured to generate a first primary X-ray fan-beam;
a second primary collimator configured to generate a second primary X-ray fan-beam;
a support for positioning an object downstream from said first primary collimator and said second primary collimator;
a first scatter detector array configured to detect a first set of scattered radiation generated upon intersection of the first primary X-ray fan-beam with the object;
a second scatter detector array configured to detect a second set of scattered radiation generated upon intersection of the second primary X-ray fan-beam with the object; and
at least one processing device coupled to said first scatter detector and to said second scatter detector and configured to generate at least a portion of a diffraction profile from the first set of scattered radiation and the second set of scattered radiation.

12. An object imaging system in accordance with claim 11, wherein said X-ray source has a dimensionality of one of zero, one, and two.

13. An object imaging system in accordance with claim 11, wherein said first primary collimator and said second primary collimator are configured to generate at least one of:
parallel multiple-plane divergent fan-beams;
divergent multiple-plane divergent fan-beams;
parallel multiple-plane inverse fan-beams;
divergent multiple-plane inverse fan-beams;
parallel multiple-plane parallel fan-beams; and
divergent multiple-plane parallel fan-beams.

14. An object imaging system in accordance with claim 11, wherein said first scatter detector array is configured to generate a plurality of electrical output signals based on the detected scattered radiation at substantially the same time as said second scatter detector array is generating a plurality of electrical output signals based on the detected scattered radiation.

15. An object imaging system in accordance with claim 14, wherein said at least one processing device is further configured to generate an XRD profile from the electrical output signals.

16. An object imaging system in accordance with claim 11, wherein said first scatter detector array is positioned more than a predetermined distance from said second scatter detector array, the distance predetermined to prevent coherent scatter from the first set of scattered radiation from reaching said second scatter detector array, and to prevent coherent scatter from the second set of scattered radiation from reaching said first scatter detector array.

17. An object imaging system in accordance with claim 11, further comprising a first scatter collimator associated with said first scatter detector array and a second scatter collimator associated with said second scatter detector array, said first scatter collimator configured to prevent coherent scatter from the second set of scattered radiation having an angle of incidence of greater than a maximum angle from reaching said first scatter detector array, said second scatter collimator configured to prevent coherent scatter from the first set of scattered radiation having an angle of incidence of greater than a maximum angle from reaching said second scatter detector array.

18. A method for assembling an object imaging system, said method comprising:
configuring at least one X-ray source/primary collimator combination to generate a plurality of X-ray diffraction (XRD) fan-beams, the plurality of XRD fan-beams including a first primary XRD fan-beam and a second primary XRD fan-beam;
configuring the at least one X-ray source/primary collimator combination to direct the first primary XRD fan-beam toward a first X-ray detector with at least one object positioned between the X-ray source/primary collimator combination and the first X-ray detector;
configuring the at least one X-ray source/primary collimator combination to direct the second primary XRD fan-beam toward a second X-ray detector with the at least one object positioned between the X-ray source/primary collimator combination and the second X-ray detector;
positioning an object support downstream from the at least one X-ray source/primary collimator combination, the object support configured to position the at least one object such that at least a portion of the first primary XRD fan-beam is scattered within a portion of the at least one object to form a first X-ray scatter beam and at least a portion of the second primary XRD fan-beam is scattered within a portion of the at least one object to form a second X-ray scatter beam;
configuring the first X-ray detector to detect the first X-ray scatter beam;
configuring the second X-ray detector to detect the second X-ray scatter beam; and
configuring a processing system coupled to the first X-ray detector and the second X-ray detector to generate at least a portion of an XRD profile from the first X-ray scatter beam and the second X-ray scatter beam.

19. A method in accordance with claim 18, wherein configuring the at least one X-ray source/primary collimator combination to generate a plurality of XRD fan-beams comprises configuring the X-ray source/primary collimator combination to generate diverging multiple divergent fan-beams generated from X-rays provided by an X-ray source having a dimensionality of zero.

20. A method in accordance with claim 18, wherein configuring the at least one X-ray source/primary collimator combination to generate a plurality of XRD fan-beams comprises configuring the X-ray source/primary collimator combination to generate at least one set of:
parallel multiple divergent fan-beams generated from X-rays provided by an X-ray source having a dimensionality of one; and
diverging multiple inverse fan-beams generated from X-rays provided by the X-ray source having a dimensionality of one.

21. A method in accordance with claim 18, wherein configuring the at least one X-ray source/primary collimator combination to generate a plurality of XRD fan-beams comprises configuring the X-ray source/primary collimator combination to generate parallel multiple inverse fan-beams from X-rays provided by an X-ray source having a dimensionality of two.

22. A method in accordance with claim 18, further comprising:
configuring the processing system to generate a plurality of energy spectra from a three-dimensional distribution of voxels of the at least one object; and
configuring the processing system to analyze the plurality of energy spectra from the three-dimensional distribution of voxels in parallel to generate a three-dimensional XRD image of the at least one object.
